(19) United States
(12) Patent Application Publication
(10) Pub. No.: US 2009/0127184 A1
(43) Pub. Date: May 21, 2009

(54) Flow-Through Device for The Treatment of a Fluid and Flow-Through Element Used Thereby

(75) Inventors: Bart Hubert Edith Pauwels, Breendonk (BE); Manuel Paula Albert Vandevoorde, Bornem (BE)

Correspondence Address: BACON & THOMAS, PLLC, 625 SLATERS LANE, FOURTH FLOOR, ALEXANDRIA, VA, 22314-1176, US

(73) Assignee: ATLAS COPCO AIRPOWER NAAMLOZE VENNOOTSCHAP, WILRIJKE (BE)

(21) Appl. No.: 12/223,715

(22) PCT Filed: Feb. 9, 2007
(86) PCT No.: PCT/BE2007/000016

§ 371 Date: Aug. 7, 2008

(30) Foreign Application Priority Data
Feb. 1, 2006 (BE) 2006/0087

(51) Int. Cl. B01D 27/00

(52) U.S. Cl. 210/441; 210/437

(57) ABSTRACT

Flow-through device for treating a fluid, mainly including a housing in the shape of a pot (2) with a lid (3) which is provided with an inlet (4) and an outlet (5) for the fluid and an exchangeable tubular flow-through element (6) provided in the housing which is provided with a medium (7) for treating the fluid, whereby this element (6) fits against the lid (3) and forms a separation between the space (12) on the inside of the element (6) which is connected to the inlet (4) and the space (16) on the outside of the element (6) which is connected to the outlet (5), wherein in the space (12), on the inside of the element (6) opposite the inlet (4), is provided a tube (20) forming an extension of the inlet, which tube mainly extends in the axial direction (X-X′) of the element (6) and which is provided with lateral passages (21) for evenly distributing the fluid to be treated over the length of the flow-through element (6), whereby this tube has a narrowing cross section lengthwise in the axial direction of the flow of the fluid through the tube (20).

The present invention concerns an improved flow-through device for treating a fluid, for example for filtering out impurities from a gas or liquid, for drying a gas, for separating condensate from a gas, or the like.

Such flow-through devices of the type which mainly consist of a housing in the shape of a pot with a lid which is provided with an inlet and an outlet for the fluid and an exchangeable tubular flow-through element provided in the housing, which is provided with a medium for treating the fluid, whereby this element fits against the lid and forms a separation between the space on the inside of the element which is connected to the inlet and the space on the outside of the element which is confined by the housing and which is connected to the outlet.

The untreated fluid is directed via the inlet and the space on the inside of the element through the element, as a result of which for example impurities or condensate in the medium of the element are stopped, after which the medium is discharged as treated medium via the space on the outside of the element and the outlet for further use.

A disadvantage of the known flow-through devices is that when flowing through the element, the fluid is not evenly distributed over the entire length of the element, but the major part of the flow rate of the fluid only flows through a part of the element, namely the part closest to the inlet.

This is disadvantageous in that the remaining part of the element is used less efficiently and the pressure loss over the element is relatively large, since the flow is only forced through a limited part of the element. The pressure loss mainly depends on the local speed which rises as a result of the flow being forced through a smaller surface.

From WO 2004/009210 is already known a possible improvement in the form of a shorter tube provided centrally in the extension of the inlet and which has a diameter which is smaller than that of the inlet so as to make a part of the flow rate flow out via the short tube somewhat farther away from the inlet in the space on the inside of the element.

However, this solution is not sufficient and is still disadvantageous in that the fluid is distributed unevenly over the length of the element and in that certain zones of the medium are used less efficiently than other zones.

The present invention aims to remedy the above-mentioned and other disadvantages.

To this end, the invention concerns a flow-through device of the above-mentioned type whereby a tube is provided in the space on the inside of the element opposite the inlet, which tube mainly extends in the axial direction of the element and which is provided with lateral passages for evenly distributing the fluid to be treated over the length of the flow-through element, whereby this tube has a cross section narrowing in the longitudinal direction, in the axial direction of the flow of the fluid through the tube.

The fluid to be treated is distributed over the length of the element through the narrowing tube via the passages, as a result of which the medium of the element is used more efficiently and as a result of which the pressure losses through the filter can be reduced up to 30%.

Such a tube can moreover be realised in a simple and cheap manner, as a result of which the cost price of such an improved flow-through device is limited.

The invention also concerns a flow-through element comprising a tube with a section which narrows in the longitudinal direction, which tube is provided with lateral passages and which can be applied in a flow-through device according to the invention.

In order to better explain the characteristics of the invention, the following preferred embodiments of an improved flow-through device and flow-through element according to the invention are given as an example only without being limitative in any way, with reference to the accompanying drawings, in which:

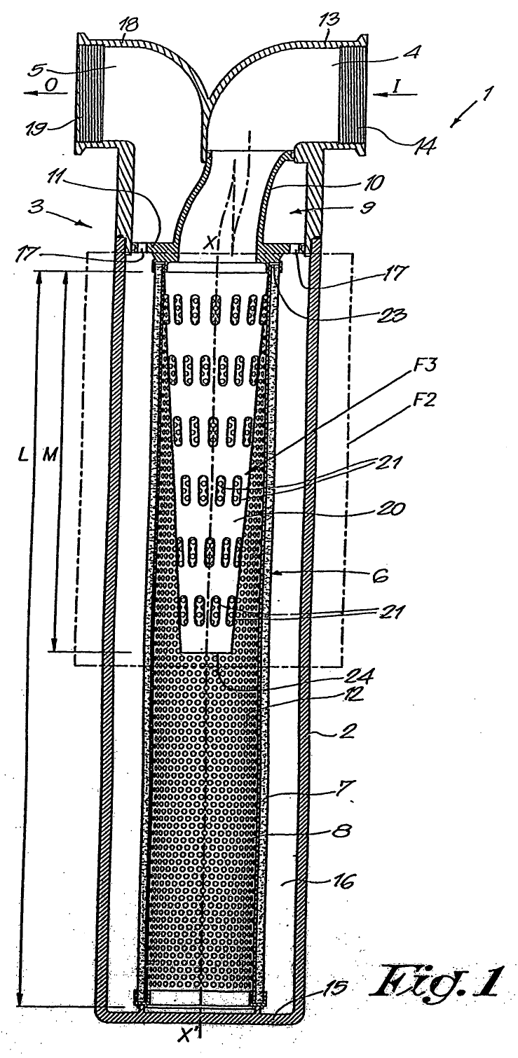

FIG. 1 represents a section of an improved flow-through device according to the invention;

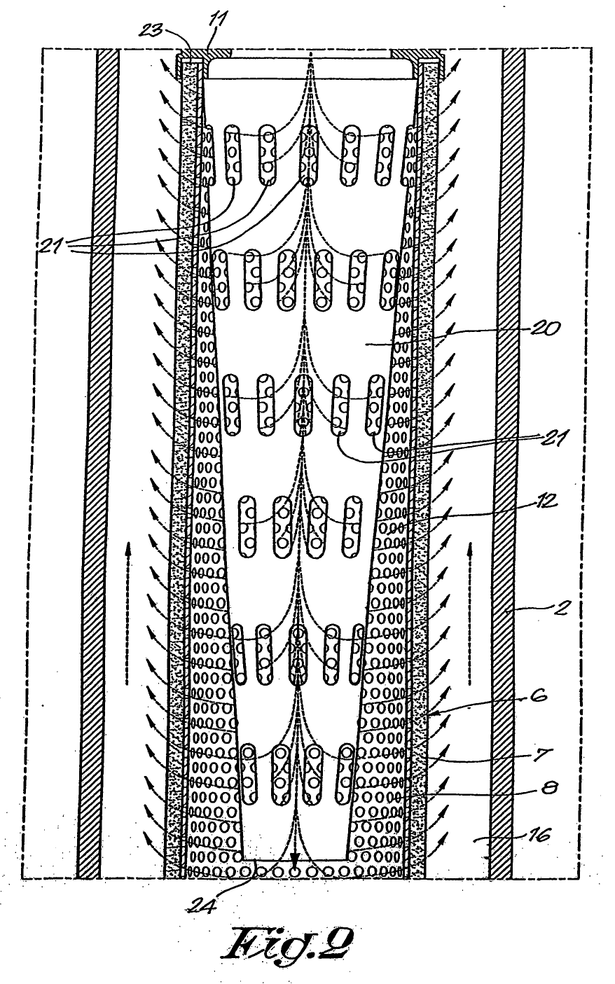

FIG. 2 represents the part indicated by F2 in FIG. 1 to a larger scale;

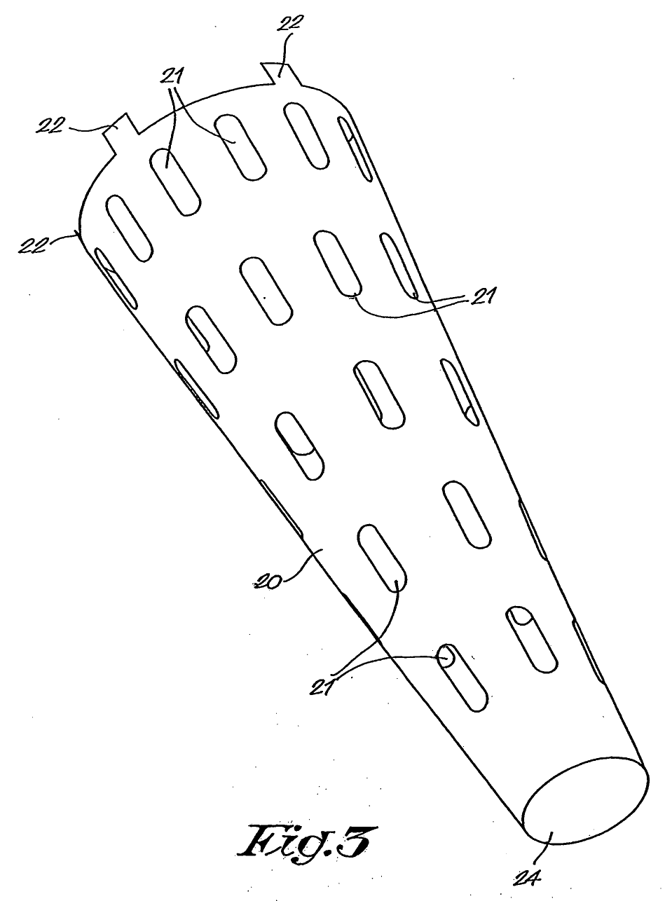

FIG. 3 is a view in perspective of the part indicated by F3 in FIG. 1;

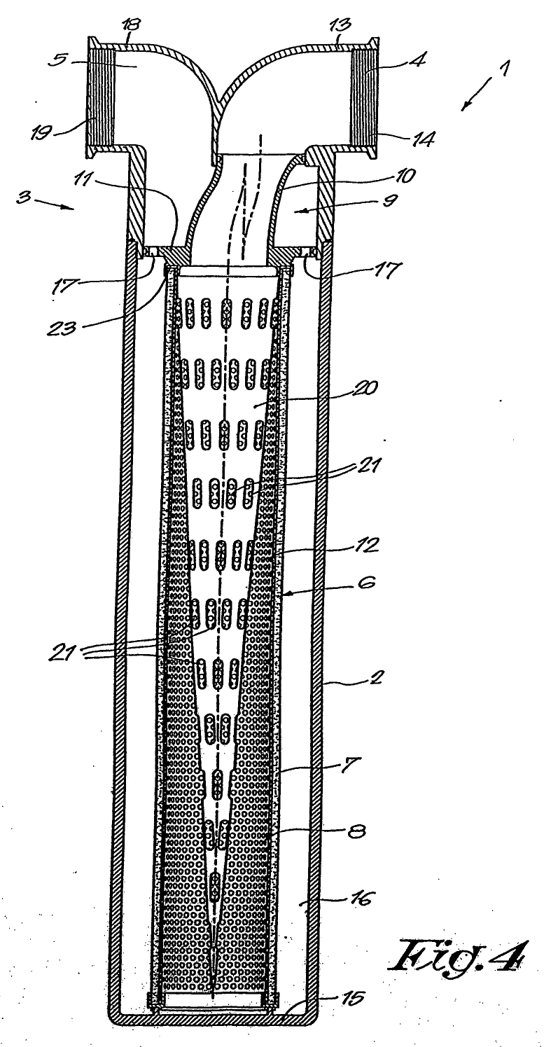

FIG. 4 represents a variant of FIG. 1.

The flow-through device 1 represented in FIGS. 1 to 3 mainly consists of a housing in the shape of a pot 2 with a lid 3 which is provided with an inlet 4 and an outlet 5 for the fluid and an exchangeable tubular flow-through element 6 provided in the housing.

The flow-through element 6 is provided with a medium 7 for treating the fluid, whereby this medium 7 consists for example of a filter material which is suitable to stop impurities or condensate drops, or of a desiccant for removing moisture from the fluid to be treated, or of a catalyst or of other active or passive components.

In the given example, the medium 7 is for example a sort of filtering cloth provided round a supporting porous or perforated tube 8 of the element 6, whereby it is also possible for the medium 7 to be supported between two concentric porous or perforated tubes, such that the medium 7 is supported along either side.

The element 6 is in this case provided at its top end with a head 9 formed of plastic or the like which goes in the above-mentioned lid 3 and fits against it so as to form the above-mentioned inlet 4 and outlet 5.

The above-mentioned head 9 of the element 6 is provided with a bent canalisation tube 10 with an annular flange 11 which is held in the lid 3 by means of radial supporting ribs or the like, whereby this canalisation tube 10 is connected to the inner space 12 with one far end on the inside of the element 6 and fits with the other far end in a hooked nipple 13 of the lid 3, which nipple 13 is threaded 14 in view of the connection of a supply tube for the fluid to be treated.

The element 6 rests with its lower end on the bottom 15 of the pot 2 of the housing and thus forms a separation between the above-mentioned space 12 on the inside of the element 6 which is connected to the inlet 4 and the space 16 on the outside of the element 6 which is confined by the element 6 itself and by the housing and which is connected to the outlet 5 via a passage 17 round the above-mentioned annular support 11, whereby this outlet 5 opens in a nipple 18 which is threaded 19 in view of the connection of a discharge pipe for treated fluid.

The passage 17 is preferably made large enough, so as not to cause any additional pressure losses.

On the lower side of the pot 2 is provided another opening which is not represented in the figures and via which the impurities and the condensate drops can be discharged via a drain under the filter element which can be opened manually or automatically so as to let the condensate flow away.

According to the invention, a tube 20 is provided in the space 12 on the inside of the element 6 opposite the inlet 4, in the given example a conical tube which is not part of the flow-through element, with a cross section which narrows in the longitudinal direction, which mainly extends in the axial direction X-X′ of the element 6 and which is provided with lateral passages 21.

The tube 20 is fixed to the above-mentioned head 9 with its widest end by gluing a few fixing lips 22 which are first clamped in a groove 23 provided in the head 9 of the element 6. The rest of the element 6, i.e. the filtering cloth 7 and the supporting tube or tubes 8, are at the same time glued in the groove as well.

Alternatively, the tube 20 can also be fixed with its widest end to the innermost perforated tube 8 by welding the fixing lips 22 on the inside of this tube 8.

This whole formed of tube 8 and tube 20 can then be glued in the groove 23 of the head 9 together with the filtering cloth 7 and a possible outermost perforated tube.

The conical tube 20 so to say forms an extension of the inlet 4 or in particular of the canalisation tube 10.

The lateral passages 21 are preferably distributed according to a regular pattern over the circumference of the tube 20 and they open in the space 12 on the inside of the element 6 at different distances from the inlet 4.

The passages 21 may have all sorts of shapes, such as slots which mainly extend in the longitudinal direction of the element 6.

In the embodiment of FIGS. 1 to 3, the tube 20 extends over only a part of the length L of the element 6, preferably over a length M situated between ⅓ and ⅘ of the length L of the element 6, or better still situated between 40% and 70% of the length L of the element 6.

In this case, the tube 20 is open at its narrowest end so as to form an axial output 24, whereby the diameter of this output 24 is preferably situated between 20% and 50% of the diameter of the widest end of the tube 20 and preferably in the order of magnitude of 40% of the diameter of this widest end.

The working of the flow-through device 1 according to the invention is simple and as follows.

The fluid to be treated flows in from the flow-through device 1 via the inlet 4 in the direction of the arrow I and is directed axially through the conical tube 20 via the canalisation tube 10.

The flow of the fluid to be treated is blown into the space 12 via the lateral passages 21 and via the axial output 24, as represented by the arrows in the dashed line in FIG. 2.

The fluid to be treated is thus evenly distributed over the entire length L of the element 6 and is pressed into the space 12 on the inside of the element 6 by the static pressure, through the medium 7 of the element 6 to the outside of the element 6.

The treated fluid is then collected in the space 16 on the outside of the element 6 and discharged via the openings 17 and the outlet 5 in the direction of the arrow O for further use or treatment.

There are two reasons why such a flow-through device 1 according to the invention has a lower pressure drop and is more efficient in use.

On the one hand, the static pressure in the space 12 on the inside of the element 6 is distributed more uniformly, which implies that the flow is spread more evenly over the entire length L of the element, since this static pressure is the driving force to push the fluid through the medium 7 of the element 6.

On the other hand, the fluid is blown deeper in the element 6 in the axial direction X-X′, which is also favourable for a better flow distribution of the fluid over the length L of the element 6 and which results in a smaller pressure drop over the flow-through device 1.

By applying the conical tube 20, the pressure drop over the flow-through device 1 can be reduced to at least 10% or, depending on the application, the pressure losses can be even reduced by at least 20% or better still by 30%.

Depending on the shape and dimensions of the flow-through device 1 and on the nature of the medium 7, the effect of the conical tube 20 can be optimised by choosing the right shape and dimensions, as well as the right number and position for the conical tube 20 and for the lateral passages 21, as well as the right shape and dimensions for the axial output 24.

FIG. 4 represents the most preferred embodiment, whereby the conical tube 20 in this case extends over the entire or practically the entire length L of the element 6 and whereby the conical tube 20 is pointed in this case and is closed at its narrowest end.

It is clear that the conical tube 20 can be made of all sorts of materials, although stainless steel or plastic is preferred.

The present invention is by no means limited to the embodiments given as an example and represented in the figures; on the contrary, such an improved flow-through device can be made in all sorts of shapes and dimensions while still remaining within the scope of the invention.

1-14. (canceled)

15. Flow-through device for treating a fluid, comprising a housing in the shape of a pot with a lid which is provided with an inlet and an outlet for the fluid and an exchangeable elongate tubular flow-through element provided in the housing which extends along an axis and is provided with a medium for treating the fluid, wherein said element fits against the lid and forms a separation between a space on the inside of the element which is connected to the inlet and a space on the outside of the element which is connected to the outlet, wherein in a space on the inside of the element that is opposite the inlet there is provided a tube forming an extension of the inlet, which tube extends in the axial direction of the element and which is provided with lateral passages for evenly distributing the fluid to be treated over the length of the flow-through element, wherein said tube has a narrowing cross section extending lengthwise in the axial direction of the flow of the fluid through the tube and wherein a space on the outside of the element is connected to the outlet via a passage in an annular flange in the lid.

16. Flow-through device according to claim 15, wherein the tube is conical in shape.

17. Flow-through device according to claim 15, wherein the lateral passages in the tube are provided at different distances from the inlet.

18. Flow-through device according to claim 15, wherein the lateral passages are distributed over a circumference of the tube.

19. Flow-through device according to claim 15, wherein the tube extends over the entire, or substantially over the entire, length of the element.

20. Flow-through device according to claim 19, wherein the tube is closed at its narrowest end.

21. Flow-through device according to claim 15, wherein the tube extends over a length which is situated between one third and four fifths of the length of the element.

22. Flow-through device according to claim 15, wherein the tube is open at its narrowest end.

23. Flow-through device according to claim 22, wherein the diameter of the open narrowest end of the tube is between 20% and 50% of the diameter of the widest end of the tube.

24. Flow-through device according to claim 15, wherein the lateral passages are slots which extend primarily in the longitudinal direction of the element.

25. Flow-through device according to claim 15, wherein the tube is fixed to the lid at the widest end of the tube.

26. Flow-through device according to claim 15, wherein the element is provided with a head which is adapted to cooperate with the lid so as to define the inlet and outlet and wherein the tube is fixed to the head of said element.

27. Flow-through device according to claim 15, wherein the tube reduces the pressure losses through the flow-through device by at least 10%.

28. Flow-through element for use in a flow-through device according to claim 15, comprising a tube having a cross section which narrows in a longitudinal direction and is provided with lateral passages.
